(19) United States
(12) Patent Application Publication
(10) Pub. No.: US 2007/0107401 A1
(43) Pub. Date: May 17, 2007

(54) Artistic lawn sculpting machine

(76) Inventor: Javad Jafarifar, Henderson, NV (US)

Correspondence Address: JOHN V STEWART, 1308 HENRY BALCH DRIVE, ORLANDO, FL, 32810, US

(21) Appl. No.: 11/261,074

(22) Filed: Oct. 28, 2005

(51) Int. Cl. A01D 34/00

(52) U.S. Cl. 56/12.7

(57) ABSTRACT

A grass cutting machine using flail-type centrifugally stiffened blades (32) pivotally mounted on a cutter hub (30) on a motor shaft (28). The cutter and a motor assembly (20, 22) are mounted on wheels (42). Preferably the cutter rotation axis is parallel to the direction of travel. This efficiently sculpts a concave channel (62) in grass as the machine is rolled across a lawn (60). A laterally extending guide tube (46) may be attached to the machine to visually guide a user in cutting a channel parallel to a previously cut channel.

### BACKGROUND OF THE INVENTION

1. Field of the Invention

This invention relates to methods and machines for creating artistic patterns in lawns, and also to machines for cutting lawns.

2. Description of Prior Art

Various types of grass cutting technologies are known, including a horizontal rotating blade known as a rotary mower, a horizontal helical shearing cutter known as a reel-type mower, and rotating flails of several types, such as a flexible cord extending radially from a rotating hub and stiffened by centrifugal force. Flails also include rigid or semi-rigid blades or cords that are pivotally attached to a rotating hub, and are urged into radial orientation by centrifugal force. An advantage of flails is that they can withstand contact with solid objects such as walls, landscaping borders, tree roots, etc., with less damage to the solid object and less damage to the cutter than with rigid blades.

Grass playing fields for professional sports are often prepared by lawn keepers to show geometric patterns such as circles, lines, letters, and portraits. A common way of doing this is to mow the grass using a reel-type mower with a roller behind the cutter that bends the grass leaves in the direction of travel. The mower is used in different directions to make the grass appear in patterns of darker and lighter stripes. Where the grass leans toward an observer, it appears darker. Where it leans away from an observer, it appears lighter. Rotary mowers can also be used if they have a following roller. However, reel-type mowers produce a cleaner and more uniform cut that can be more uniformly bent by a roller.

Another pattern-making method is to mow a field uniformly with a reel or rotary type mower, then make a pattern in the grass using rollers only. For example, in the pattern-making stage, a mower with rollers can be used with the cutter turned off, so only the rollers are used. This method makes it easier to cut the lawn evenly without missing spots, then concentrate on the route for making the pattern.

### SUMMARY OF THE INVENTION

An objective of this invention is to provide a lawn sculpting machine that efficiently cuts channels of shorter grass in a previously mowed lawn to produce artistic patterns on the lawn.

This objective is met with a grass cutter using flail-type centrifugally stiffened blades pivotally mounted on a cutter hub on a motor shaft. The cutter and a motor assembly are mounted on wheels. Preferably the cutter rotation axis is parallel to the direction of travel. This efficiently sculpts a concave channel in grass as the machine is rolled across a lawn. A laterally extending guide tube may be attached to the machine to visually guide a user in cutting a channel parallel to a previously cut channel.

### BRIEF DESCRIPTION OF THE DRAWINGS

FIG. 1 is a schematic view of a first design concept for cutting grooves in grass;

FIG. 2 is a schematic view of a second design concept for cutting grooves in grass;

FIG. 3 is a schematic view of a preferred design concept for cutting grooves in grass;

FIG. 4 is a perspective view of a multiple cutter hub array.

FIG. 5 is a front view of the multiple cutter hub array of FIG. 4.

FIG. 6 is a top sectional view of a grass sculpting machine according to aspects of the invention, taken on a section plane through the axis of the motor shaft;

FIG. 7 is a perspective front view of a machine as in FIG. 6 with the motor turned off;

FIG. 8 is a top view of a machine as in FIG. 6 cutting a parallel line on a lawn using a guide tube.

### REFERENCE CHARACTERS

20. Motor case

22. Motor or engine

24. Cooling air

26. Cooling air inlet filter

28. Motor shaft

29. Shaft rotation

30. Cutter hub

30A. First cutter hub in a multiple cutter hub array

30B. Second cutter hub in a multiple cutter hub array

30C. Third cutter hub in a multiple cutter hub array

30D. Fourth cutter hub in a multiple cutter hub array

32. Cutter blade or flail

32A. Cutter blade on first cutter hub in multiple cutter hub array

32B. Cutter blade on second cutter hub in multiple cutter hub array

32C. Cutter blade on third cutter hub in multiple cutter hub array

32D. Cutter blade on fourth cutter hub in multiple cutter hub array

34. Cutter flail pivot pin

36. Air impeller

38. Cutter safety shroud

40. Cutter discharge chute

42. Wheel

44. Axle

46. Cutting guide tube

48. Cutting guide pivot

50. Cutting guide extension adjustment

52. Handle tube

54. Handle bar

60. Grass

62. Groove cut into grass

### DETAILED DESCRIPTION

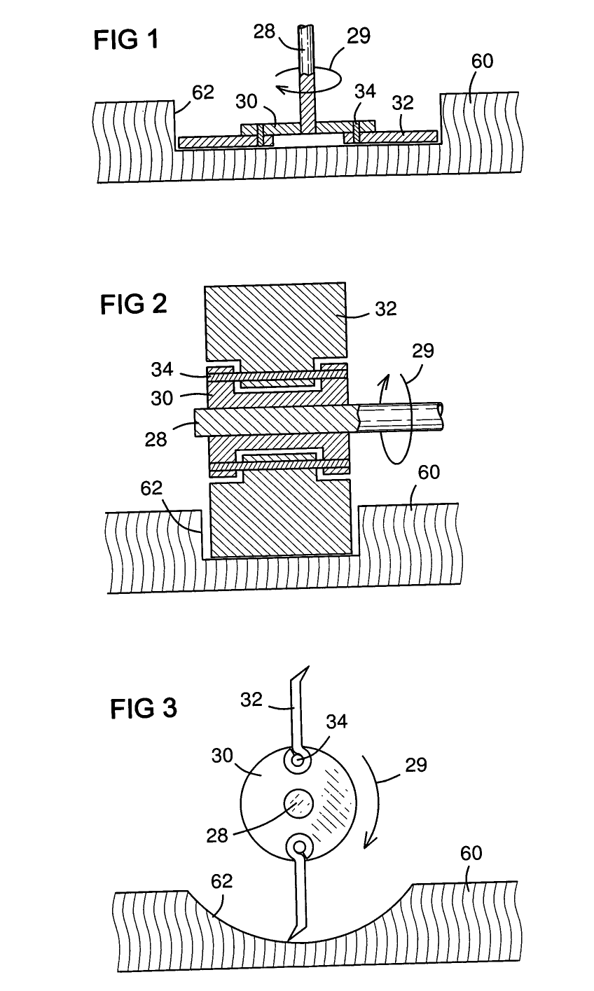

FIG. 1 shows a schematic view of a first type of cutter, in which blades or flails 32 are mounted on a vertical shaft 28. The cut profile 62 produced by this design has a rectangular shape. The corners of this profile can be rounded slightly with a curved blade. However, a concave arcuate profile as later described is impractical with the design of FIG. 1, because a fully arcuate blade would not cut grass near the shaft. Also, flail-type cutting elements 32 cannot provide a circular arcuate geometry in the configuration of FIG. 1, even if the flail elements are rigid, because centrifugal force will cause them to extend horizontally from the pivot pin 34 based on their average mass density, rather than curve upward.

FIG. 2 shows a schematic view of a second type of cutter, in which blades or flails 32 are mounted on a horizontal shaft that is transverse to the travel direction. This configuration can produce any type of cut profile 62 based on the curvature of the blade edges. However, cutting efficiency is low for two reasons: 1) the grass is cut repeatedly shorter and shorter as the cutter advances. Thus, the grass is cut many times, rather than just once. 2) If the blade edge is curved, its speed will vary with radial distance from the axis. The blade must rotate fast enough to effectively cut grass at the shortest part of the blade. This gives excess speed to the longest part of the blade, causing excess air resistance.

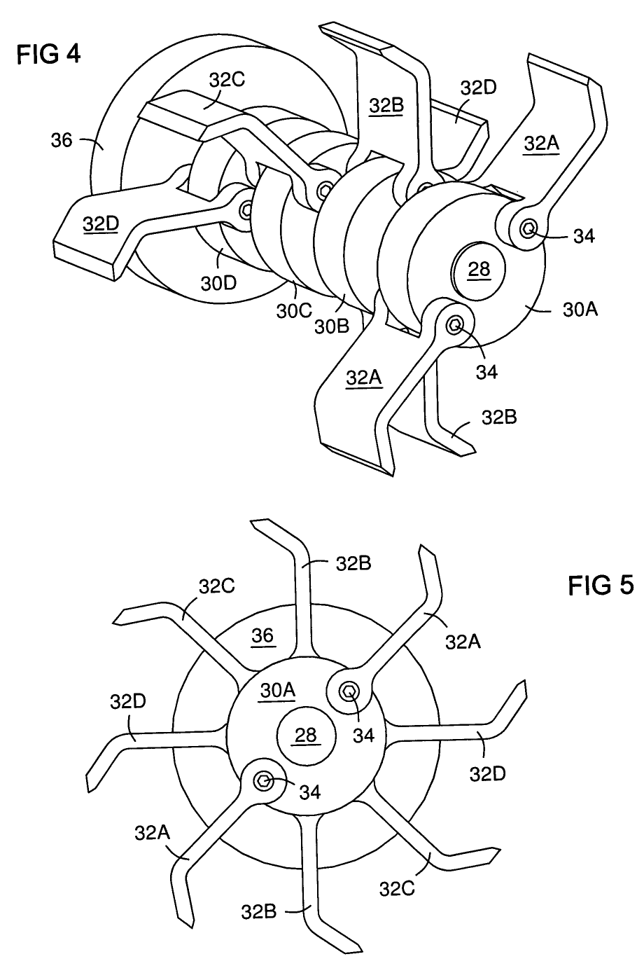

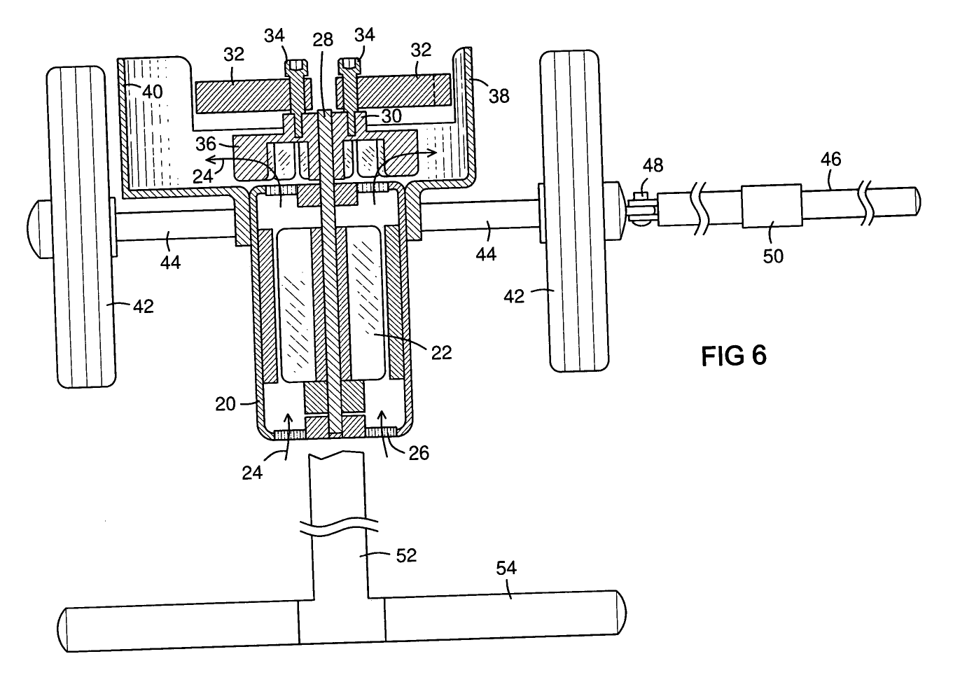

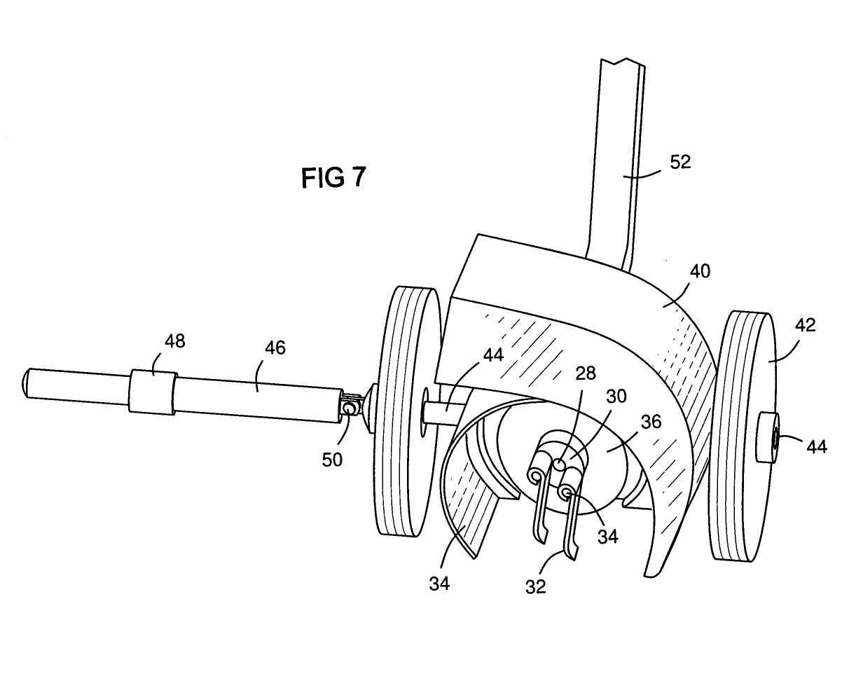

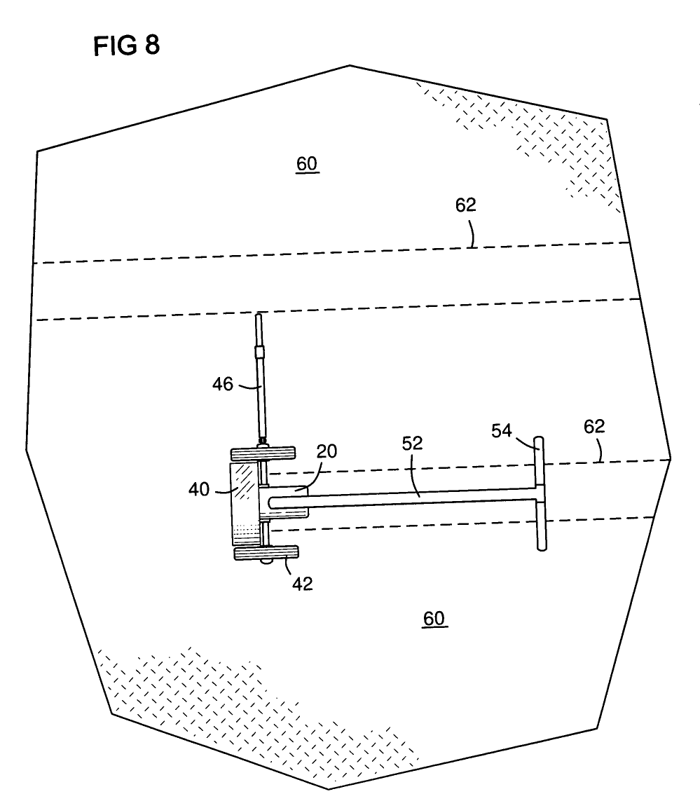

The configuration of FIG. 3 has none of these disadvantages, and is the preferred embodiment of this invention. Blades or preferably flails 32 are mounted on a horizontal rotary shaft 28 that is aligned with the direction of travel. A motor or engine 22 drives the rotary shaft 28. Herein “motor” means any rotary drive means, such as an electric motor as shown or an internal combustion engine. The motor and other parts may be assembled on a chassis or frame (not shown) or the motor case 20 may provide attachment points for the other parts for example by bolts. In the claims “attached to the motor case” means directly or indirectly attached, for example by attachment to another part that is directly or indirectly attached to the motor case. The flails 32 are mounted on pivot pins 34, and extend radially from a cutter hub 30 under centrifugal force. The pivot pins 34 may for example be in the form of shoulder pins with a narrowed threaded end, as shown in FIG. 6.

FIGS. 4 and 5 show a multiple hub cutter array that can be used in the orientation of either FIG. 2 or FIG. 3. A plurality of hubs 30A, 30B, 30C, 30D are mounted in an axial sequence on a common shaft 28. Each hub has respective blades 32A, 32B, 32C, 32D. Each hub is rotationally offset from the adjacent hub as shown. The number of hubs, blades per hub, and the offset angles may vary.

The distal ends of the rotating flails 32 describe a cutting circle. A safety shroud 38 surrounds at least a part of cutting circle, including radially around it except below it. A discharge chute 40 extends from the shroud to discharge grass cuttings. An air impeller 36 is attached to the cutter hub 30 to provide air flow 24 for grass discharge. The impeller may also provide air flow to cool the motor. For example an electric motor 22 may be arranged as shown in FIG. 6 with air filters 26 in back of the motor case 20 for inlet air 24. This air flow passes over the motor and then forward through the impeller 36 and out the discharge chute 40.

A handle tube 52 may be provided with a proximal end attached to the motor case or chassis. The handle tube has a distal end with a handle bar 54 for pushing the sculpting machine in a direction of travel. At least two transport wheels 42 are mounted on respective parallel axles 44 attached to the motor case or chassis. Preferably two transport wheels 42 are mounted on opposite ends of a single axle 44 as shown. In the claims, the term “substantially parallel axles” includes the situation in which a single axle is used for two wheels. A two-wheel configuration as shown allows the user to make cutting depth adjustments by changing the vertical angle at which the handle tube 52 is held. The handle tube 52 preferably has length adjustability (not shown), using known means such as bolts or spring-loaded pins in selectable holes.

Artistic patterns often require parallel lines, as in for example concentric circles and checkerboard patterns. A laterally extendable guide tube 46 may be provided to visually guide the user in cutting parallel lines. The guide tube has a length adjustment 50. For example the guide tube may comprise telescoping nested tubes locked with a threaded collet sleeve 50 or other known means. The user sets the length of the guide tube to a desired distance between parallel cuts. Then the user pushes the machine beside a previous cut while visually maintaining the distal end of the guide tube over the previous cut. A rubber band may be provided on the proximal segment of the guide tube to provide a distance indication when it is shorter than the proximal segment of the tube. The guide tube is mounted by a pivot attachment 48 on a distal end of a wheel axle or on another stationary part. It has a pivot stop that holds the guide tube approximately horizontal, but allows it to be folded upward or against the handle tube when not in use.

Although the present invention has been described herein with respect to preferred embodiments, it will be understood that the foregoing description is intended to be illustrative, not restrictive. Modifications of the present invention will occur to those skilled in the art. All such modifications that fall within the scope of the appended claims are intended to be within the scope and spirit of the present invention.

1. A lawn sculpting machine, comprising:
a motor that drives a rotary shaft, the shaft having an axis of rotation, the motor having a case;
a cutter hub attached to the rotary shaft;
a cutter blade member having a proximal end attached to the cutter hub and having a distal end;
at least two transport wheels attached to the motor case for rolling transport across a lawn in a travel direction;
the motor rotating the distal end of the blade to describe a cutting circle;
a protective shroud surrounding at least a part of cutting circle except below it;
a guide tube having a proximal end pivotally attached to the motor case;
the pivot attachment of the guide tube having a stop that holds the guide tube approximately horizontal extending laterally;
a grass discharge chute on the shroud; and
an air impeller on the cutter hub for blowing grass through the discharge chute.

2. The lawn sculpting machine of claim 1, wherein the guide tube is pivotally attached to a distal end of an axle of a given one of the transport wheels, and extends laterally beside the given wheel.

3. The lawn sculpting machine of claim 1, wherein the rotary shaft is oriented approximately in alignment with the travel direction.

4. The lawn sculpting machine of claim 1, wherein the rotary shaft is oriented approximately vertically.

5. The lawn sculpting machine of claim 1, wherein the rotary shaft is oriented approximately horizontally and transverse to the travel direction.

6. The lawn sculpting machine of claim 1, wherein a plurality of cutter hubs are attached in an axial sequence on the rotary shaft, each cutter hub having at least two cutter blade members, and the cutter blade members of adjacent cutter hubs on the shaft are rotationally offset from each other.

7. A lawn sculpting machine, comprising:
a motor that drives a rotary shaft, the shaft having an axis of rotation, the motor having a case;
a cutter hub attached to the rotary shaft;
a cutter blade member having a proximal end attached to the cutter hub and having a distal end;
at least two transport wheels attached to the motor case for rolling across a lawn in a travel direction, the rotary shaft oriented approximately in alignment with the travel direction;
the motor rotating the distal end of the blade to describe a cutting circle; and
a protective shroud surrounding at least a part of cutting circle, including behind it and radially around it except below it.

8. The lawn sculpting machine of claim 7, further comprising:
a guide tube having a proximal end pivotally attached to the motor case; and
the guide tube being pivotal to a lateral position, and extendable in length with a lockable extension adjustment.

9. The lawn sculpting machine of claim 7, wherein the blade is pivotally attached to the cutter hub, and further comprising:
a grass discharge chute on the shroud;
an air impeller on the cutter hub for blowing grass through the discharge chute; and
a handle tube having a proximal end attached to the motor case and having a distal end with a handle bar for pushing the sculpting machine in the direction of travel.

10. The lawn sculpting machine of claim 9, further comprising an air flow path through the motor into the shroud; and wherein the air impeller simultaneously draws cooling air through the motor and blows grass through the discharge chute.

11. The lawn sculpting machine of claim 7, wherein a guide tube is pivotally attached to a distal end of an axle of a given one of the transport wheels, and extends laterally beside the given wheel from the hub of the given wheel.

12. The lawn sculpting machine of claim 7, wherein a plurality of cutter hubs are attached in an axial sequence on the rotary shaft, each cutter hub having at least two cutter blade members, and the cutter blade members of adjacent cutter hubs on the shaft are rotationally offset from each other.

13. A lawn sculpting machine, comprising:
a motor that drives a rotary shaft, the shaft having an axis of rotation, the motor having a case;
a cutter hub attached to the rotary shaft;
a cutter blade member attached to the cutter hub;
a plurality of transport wheels with substantially parallel axes providing a direction of travel over a lawn surface;
the motor case attached to the transport wheels, the rotary shaft axis oriented approximately in the direction of travel;
a telescoping guide tube having a proximal end pivotally attached to the motor case;
the pivotal attachment of the guide tube having a stop that holds the guide tube approximately horizontal extending laterally; and
the telescoping guide tube having a lockable telescoping extension adjustment.

14. The lawn sculpting machine of claim 13, wherein the blade is pivotally attached to the cutter hub, and further comprising:
a grass discharge chute on the shroud; and
an air impeller on the cutter hub for blowing grass through the discharge chute
a handle tube with a proximal end attached to the motor case and a distal end with a handle bar for pushing the sculpting machine in the direction of travel.

15. The lawn sculpting machine of claim 14 further comprising an air flow path through the motor into the shroud; and wherein the air impeller simultaneously draws cooling air through the motor and blows grass through the discharge chute.

16. The lawn sculpting machine of claim 13 wherein the telescoping guide tube is pivotally attached to a distal end of the axle of a given one of the transport wheels, and extends laterally beside the given wheel from the hub of the given wheel.

17. A lawn sculpting machine, comprising:
a motor that drives a rotary shaft, the shaft having an axis of rotation, the motor having a case;
a cutter hub attached to the rotary shaft;
a cutter blade member having a proximal end pivotally attached to the cutter hub and having a distal end;
at least two transport wheels attached to the motor case for rolling across a lawn in a travel direction, the rotary shaft oriented approximately in alignment with the travel direction;
the motor rotating the distal end of the blade to describe a cutting circle;
a protective shroud surrounding at least a part of the cutting circle, including behind it and radially around it except below it;
a grass discharge chute on the shroud;
an air impeller on the cutter hub for blowing grass through the discharge chute; and
a handle tube having a proximal end attached to the motor case and having a distal end with a handle bar for pushing the sculpting machine in the direction of travel.

18. The lawn sculpting machine of claim 17, further comprising:
a guide tube having a proximal end pivotally attached to the motor case, the guide tube being pivotal to a lateral position, and extendable in length with a lockable extension adjustment.

19. The lawn sculpting machine of claim 17, further comprising an air flow path through the motor into the shroud; and wherein the air impeller simultaneously draws cooling air through the motor and blows grass through the discharge chute.

20. The lawn sculpting machine of claim 17, wherein a guide tube is pivotally attached to a distal end of an axle of a given one of the transport wheels, and extends laterally beside the given wheel from the hub of the given wheel.

21. The lawn sculpting machine of claim 17, wherein a plurality of cutter hubs are attached in an axial sequence on the rotary shaft, each cutter hub having at least two cutter blade members, and the cutter blade members of adjacent cutter hubs on the shaft are rotationally offset from each other.

22. A lawn sculpting machine, comprising:
a motor that drives a rotary shaft, the shaft having an axis of rotation, the motor having a case;
a cutter hub attached to the rotary shaft;
a cutter blade member having a proximal end attached to the cutter hub and having a distal end;
at least two transport wheels attached to the motor case for rolling across a lawn in a travel direction, the rotary shaft oriented approximately in alignment with the travel direction;
the motor rotating the distal end of the blade to describe a cutting circle;
a protective shroud surrounding at least a part of the cutting circle, including behind it and radially around it except below it; and
a guide tube pivotally attached to a distal end of an axle of a given one of the transport wheels, the guide tube extending laterally beside the given wheel from the hub of the given wheel.

23. The lawn sculpting machine of claim 22, wherein the blade is pivotally attached to the cutter hub, and further comprising:
a grass discharge chute on the shroud;
an air impeller on the cutter hub for blowing grass through the discharge chute; and
a handle tube having a proximal end attached to the motor case and having a distal end with a handle bar for pushing the sculpting machine in the direction of travel.

24. The lawn sculpting machine of claim 23, further comprising an air flow path through the motor into the shroud; and wherein the air impeller simultaneously draws cooling air through the motor and blows grass through the discharge chute.

25. The lawn sculpting machine of claim 22 wherein a plurality of cutter hubs are attached in an axial sequence on the rotary shaft, each cutter hub having at least two cutter blade members, and the cutter blade members of adjacent cutter hubs on the shaft are rotationally offset from each other.
